(19) United States
(12) Patent Application Publication
(10) Pub. No.: US 2012/0145278 A1
(43) Pub. Date: Jun. 14, 2012

(54) Flat Duct Seal

(76) Inventors: Ulrich Rösch, Urbach (DE); Wladimir Jevdokimov, Koblenz (DE)

(21) Appl. No.: 13/315,418

(22) Filed: Dec. 9, 2011

(30) Foreign Application Priority Data
Dec. 9, 2010 (DE) 102010062773.9-DE

(51) Int. Cl. F16L 9/22; B23P 21/00

(52) U.S. Cl. 138/177; 29/428

(57) ABSTRACT

A duct housing for a field-flux fractionation device with first and second duct housing parts being located over top of each other in the assembled state and forming a duct. A first side of the duct is limited by a membrane arranged between the two duct housing parts sealing against the outside and thus a separation volume is determined between the first duct housing part and the membrane. A first sealing area is provided at the first duct housing part and a circumferential projection, projecting from a first area defined by the first duct housing part and in the assembled state limiting a second side of the duct and surrounding the duct with the first sealing area in the assembled state engaging the membrane in a sealing fashion.

The invention relates to a duct housing, particularly to form a duct in devices for field-flux fractionation (FFF) or for asymmetrical flux-field-flux fractionation (AF4) with a first duct housing part, preferably a plate-shaped one, and a second duct housing part, preferably a plate-shaped one, with the two duct housing parts being located over top of each other in the assembled state and forming a duct, preferably a flat duct, which is limited by a membrane arranged between the two duct housing parts in a sealing fashion towards the outside and thus determining a separated volume between the first duct housing part and the membrane.

Such duct housings are provided for example for sealing a duct-like hollow space, with e.g., during field-flux-fractionation (FFF) or the asymmetric flux-field-flux fractionation (AF4) a fractionation of fluids occurs in the duct, which is limited by a plate-like component and a membrane. The fractionation of a fluid is here the more precise and the measuring result the more informative the better the duct can be sealed, namely on the one hand in reference to the environment and on the other hand from the individual components of the duct housing.

Known duct housings are commonly embodied such that in the assembled state they comprise a plurality of parts and/or elements required for fractionation and located over top of each other. Commonly, an O-ring is inserted into a type of bottom part embodied as a lower housing part and then a frit is placed onto the lower housing part and a separating membrane is placed onto the frit. Thereupon a spacer film is arranged, which comprises a cut-out or punched section. The cut-out section of the spacer film forms, together with an upper housing part embodied as a type of lid and the membrane, the duct provided for fractionation. Thus, the spacer film represents a film-like intermediate layer.

The individual components perform a specific function in the duct housing, e.g., filtering, keeping a distance, defining duct geometry, or even the support of the membrane. For the purpose of sealing, these sealing and/or separating elements placed on top of each other are commonly clamped to each other. A clamping occurs here such that a force is applied between the two housing parts, with the force being transmitted via the spacer film. Here, the other components can also be equally compressed against each other. The housing parts are preferably embodied in a plate-shaped fashion, particularly appropriately stable and perhaps massive. Frequently the entire sealing can only be ensured such that a very high clamping force is applied upon the elements arranged over top of each other, which e.g., must occur by a multitude of screws. The high clamping force is also required in field-flux fractionation or asymmetrical field-flux fractionation because inside the device, particularly in the flat duct a pressure shall exist ranging from 5 to 15 bar, if applicable.

In devices for field-flux fractionation it can be distinguished between an interior and an exterior sealing for this housing type. Here, it is known how both types of seals can be ensured exclusively by clamping the upper and the lower housing part, which can be explained in the following briefly using the example of a device for the field-flux fractionation (FFF or also A4F). A seal is required at the spacer film both towards the upper housing part as well as towards the membrane and the lower housing part, with the edge region of the spacer film surrounding the cut-out section itself can be used as the sealing element between the upper and the lower housing part. Further, a seal is also required between the frit and the lower housing part by the O-ring. An exterior leakage is called a defective tightness, when fluid can exit towards the environment. Such exterior leakage may occur at several places, e.g., due to a leak at the upper and/or lower side of the spacer film, i.e. in the area between the upper/lower housing part and the spacer film. An interior leakage however is called a defective tightness when the fluid from the duct can exit particularly into an area between the upper housing part and the spacer film or between the spacer film and the membrane and/or the lower housing part into the cross-flow volume, by which the measurement is compromised.

In the above-known solutions it is problematic that even in case of a strong force applied between the upper and the lower housing part only an insufficient interior or exterior sealing can be achieved. Additionally, usually it cannot be excluded that during the assembly of the plurality of elements to be arranged over top of each other contaminants precipitate somewhere between these elements. This particularly applies to the large sealing area between the upper housing and the spacer film and/or between the spacer film and the lower housing part. It may also be unfavorable that the force acting upon the seal to secure the interior can only be adjusted based on the force applied upon a seal to secure the exterior seal. Last but not least, in devices of prior art parts relatively many areas are formed that must be sealed, at which later a risk for leakage can occur. Usually, it is only possible with considerable expense to determine the actual cause for the leakage. For example, when an internal leakage is given it is possible that the fluid exits in an area between the spacer film and the upper housing part, however it is also possible that fluid exits in an area between the spacer film and the membrane. It may even occur that fluid exits even through a carrier material upon which the membrane can be arranged, e.g., in order to additionally stabilize the membrane on the frit. Thus, frequently a known duct housing must be subjected to an expensive testing process in order to allow performing error analysis and to assess if and in what area the leakage occurs and to what extent said leakage can compromise the measurements.

### SUMMARY

It is an objective of the present invention to provide a duct housing that can ensure in a simple fashion a secure sealing between a membrane for ultra-filtration and an upper housing part and a lower housing part. Additionally, it is the objective to embody a duct housing such that the assembly of elements to be arranged on top of each other is possible in a more simplified fashion than in prior art. Further an objective is to design a duct housing such that the effect of a certain seal can be predetermined in a constructive manner independent from the forces applied during the assembly. Last but not least another objective includes to provide such a duct housing that the risk of damaging the membrane or a carrier material can largely be avoided during the assembly.

At least one of the above objectives is attained in a duct housing of the type mentioned at the outset which comprises a first sealing area, provided at the first duct housing part and comprising a circumferential projection, which protrudes from a first area defined by a first duct housing part and in the assembled state limiting a second side of the duct and surrounds the duct, with the first sealing section in the assembled state being in a sealing engagement with the membrane.

Accordingly, a projection is provided, off-set in reference to an area defined by the first duct housing part and in the assembled state particularly resting with a face on a surface of the membrane in a form-fitting, flush, sealing contact, in order to create an interior seal between the duct and the environment by a planar pressure upon the surface of the membrane. Thus, the duct is at least partially embodied at the first duct housing part.

According to one exemplary embodiment the duct housing may be embodied such that in the assembled state the projection compresses the membrane. The duct housing can here be particularly embodied such that, essentially independent from the pressure applied in the assembled state, the projection can compress the surface by an impression depth predetermined by the constructive design. Thus, the projection relates to a type of geometrically projecting section, perhaps in the form of a step, a collar, or also a flange or in the form of another contour convex in reference to one adjacent surface or surfaces of the first duct housing part.

The projection is therefore provided to engage the membrane in a sealing fashion and defines the duct and thus the separated volume. The duct is therefore defined by the projection at the first duct housing part, and depending on the impression depth the height of the projection affects the size of the separated volume formed in the assembled state. Thus, on the one hand the advantage develops that a separate duct-forming element, such as the spacer film of prior art, can be waived and thus the assembly is facilitated. Therefore it is no longer necessary to precisely position a spacer film and the risk of damaging the membrane during the assembly can largely be excluded. Additionally, the number of sections to be sealed can be reduced, which shows such that the first duct housing part can directly act upon the membrane. The large-area sealing areas between the upper housing part and the spacer film and/or the spacer film and the lower housing part are no longer necessary. The risk of contaminants reaching the duct housing and/or the area of the seals can be effectively reduced during the assembly.

A narrow circumferential sealing surface can be formed by the projection. In particular, the sealing surface can be embodied so narrow that it is almost linear such that already at a slight compression high pressure can be applied upon the membrane in the area of the sealing surface.

Thus it is possible to provide an interior seal of the duct towards the inside via the pressure upon the projection. The projection may comprise a rounded cross-sectional profile or be provided with beveled edges. In the assembled state a projection of such a design presses upon the surface of the membrane such that the membrane can contact the projection to continuously and/or uninterrupted, however no cutting into the membrane must be feared even if the membrane was to swell due to ambient fluids.

Here, “interior” and/or “towards the inside” refers to pointing towards the duct, and “exterior” and/or “towards the outside” refers to pointing towards the environment.

The respective duct housing part may be embodied plate-shaped, with the duct housing parts also may be called duct halves.

According to one embodiment the projection describes a contour in the form of a diamond at the first duct housing part, i.e. a convex deltoid, which defines the duct. A seal is therefore ensured directly at the edge of the duct at the surface of the membrane in a narrow, linear area, and not over a large-area section between the two duct housing parts.

The first duct housing part may comprise an individual port or passage, which is arranged at the intersection of the two diagonals of the diamond. The first duct housing part can also show three passages, by which one passage is arranged at the intersection of the two diagonals of the diamond and the two other passages being arranged at least almost in the area of the corners of the diagonals of the diamond, which is equivalent to the axis of symmetry of the diamond.

According to an exemplary embodiment the first duct housing part is embodied in the area of the duct, except for the two above-mentioned passages, as a closed, first duct housing part, which in the assembled state limits the duct towards the outside.

Additionally, the first duct housing part can directly be clamped to the second duct housing part without the forces developing here being transferred into the membrane. This way, the sealing effect, particularly in an area of an interior seal, can be achieved independent from the forces applied during the assembly.

According to one exemplary embodiment the first duct housing part and the second duct housing part are embodied such that in the assembled state they directly contact each other, at least sectionally.

This way, the duct housing parts can contact each other in the assembled state at least in the area of a contact area and/or their respective contact surfaces without any gaps, at least sectionally. By this arrangement it can be prevented that excessive forces are applied upon the membrane or the frit. The contact surface between the first duct housing part and the second duct housing part can be formed in the edge region of the first duct housing part and/or the second duct housing part; however, it may also be formed at an exterior projection, which is arranged outside the circumferential and above-described projection. The contact area can therefore represent the area by which in the assembled state the applied connection forces are essentially transferred, and the duct housing can therefore be produced in a cost-effective manner such that only in the area of this contact surface the tolerances must be complied with concerning surface quality and dimensions in order to avoid tensions.

An exterior projection may also be provided at the first duct housing part and in the assembled state of the duct housing engage a groove-like recess of the second duct housing part. In this case, the lower side of the exterior projection forms the contact surface. Optionally the contact surface can also be formed in the groove-like recess itself. This way, a simple centering of the first duct housing part in reference to the second one is easily possible during the assembly and an alignment of the duct housing parts towards each other is facilitated.

According to one embodiment the first duct housing part and/or the second duct housing part comprise a stop projecting from the duct housing part and by which the contact area is defined, with the first duct housing part in the assembled state can contact the second housing part such that any connecting force applied between the first duct housing part and the second duct housing part essentially being guided via the stop.

This way, among other things, depending on the arrangement of the support area, the projection in the first sealing area, and the thickness of the membrane it can be determined to what extent the first sealing area shall compress the membrane in the assembled state.

The first duct housing part and the second duct housing part may comprise an area with a form in a top view which at least approximately coincides with the contour describing the exterior projection. The connection elements may be provided along the entire circumferential line of the exterior projection with the same distance from each other as well as outside the exterior projection with the same distance from the exterior projection and also from the stop and here remaining easily accessible. This way it can be ensured that a force connecting the first duct housing part with the second duct housing part is created as homogenously as possible and is distributed over the projection, either during the centering of the first duct housing part in reference to the second duct housing part or during the interlocking of the two duct housing parts.

According to one exemplary embodiment the duct housing comprises a second sealing section, in which a first sealing area is provided at the first duct housing part and a second sealing area at the second duct housing part, which in the assembled state cooperate with the first sealing area in order to yield a sealing connection directly between the first and the second duct housing part for an exterior sealing. The exterior sealing can directly be ensured between the two duct housing parts or via an interposed sealing element. According to one exemplary embodiment, in the assembled state in the second sealing area the sealing element is provided in the form of a circular sealing element, such as an O-ring. The sealing element may e.g., contact the first and second duct housing part with its radially outward and radially inwardly pointing sides.

The second sealing area is arranged separated from the first sealing area and is based on an independent sealing principle.

According to one exemplary embodiment in the second sealing section a stop is provided, at which, for accepting a preferably annular sealing element, the second sealing area is laterally projecting towards the outside. In the assembled state, the sealing element can contact in a sealing fashion each the first sealing area as well as the second sealing area. The sealing element can here be installed such that the risk to be damaged by a frit or other components can be largely excluded.

According to one exemplary embodiment the above-mentioned exterior projection is arranged at the first duct housing part, and a groove-like recess is provided at the second duct housing part to accept the exterior projection, thus a defined alignment of the two duct housing parts can be achieved in reference to each other by a particularly simple design but an effective fashion.

According to an exemplary embodiment the first sealing area is formed by an interior lateral wall of the exterior projection.

According to the invention, a duct housing part may also be provided for a duct housing of a field-flux fractionation device, with in the assembled state the duct housing part rests on another duct housing part and jointly therewith forms a duct, preferably embodied as a flat duct, which is limited at one side by a membrane arranged, between the two duct housing parts and sealing towards the outside and thus a separated volume is formed between the duct housing part and the membrane, with a first sealing area being provided comprising a circular projection, which projects from a first area defined by the duct housing part and, in the assembled state, a second side of the duct and in the assembled state assumes a sealing engagement with the membrane and surrounds the duct.

According to the invention the assembly of a duct housing according to the invention may occur in three steps, with the duct housing being formed from elements to be arranged over top of each other, particularly comprising a first duct housing part and a second duct housing part, a membrane, and a sealing element, characterized in that
in a first step the elements to be arranged over top of each other are aligned to each other, with the membrane being arranged directly underneath the first duct housing part,
in a second step the first duct housing part and the second housing part are plugged together and made to contact each other via connection elements with a first force being applied such that via the sealing element already an exterior seal in reference to the environment can be created towards the outside, and
in a third step the connection elements are determined such that the first duct housing part and the second duct housing part are stressed in reference to each other with a defined force, greater than the first force, so that an interior seal can be created between the membrane and the first duct housing part. Screws may be used as connection elements, which are tightened with a predetermined torque.

### BRIEF DESCRIPTION OF THE DRAWINGS

In the following figures, the invention is explained in greater detail based on detailed information concerning prior art and additional explanations of the preferred embodiment.

FIG. 1 shows a perspective side view of a duct housing of prior art for a flat duct in an exploded illustration;

FIG. 2 shows a cross-section of a detail of the duct housing of prior art in an area, in which the spacer film rests on the membrane;

FIG. 3 shows a perspective side view of a duct housing according to a preferred embodiment of the invention in an exploded illustration;

FIG. 4 shows a perspective side view (FIG. 4a) of the first duct housing part as well as, an enlarged preferred illustration (FIG. 4b), the embodiment of a projection and an exterior projection at the first duct housing part according to the preferred embodiment of FIG. 3;

FIG. 5 shows the bottom view of the first duct housing part according to the embodiment of FIG. 3;

FIG. 6 shows in a cross-section a detail of a partial illustration of a first sealing area with the projection and a second sealing area at the first duct housing part according to the embodiment of FIG. 3;

FIG. 7 shows a cross-section of an edge section of the duct housing according to the preferred embodiment of FIG. 3 in the assembled state;

FIG. 8 shows in a schematic cross-section the operation of a sharp-edged projection (FIGS. 8a through 8c) in a direct comparison to the sealing principle according to the preferred embodiment of the invention (FIGS. 8d through 8f); and

FIG. 9 shows according to a preferred embodiment of the invention, in an enlarged cross-sectional detail, the projection as well as its geometry and arrangement in reference to a membrane.

### DETAILED DESCRIPTION

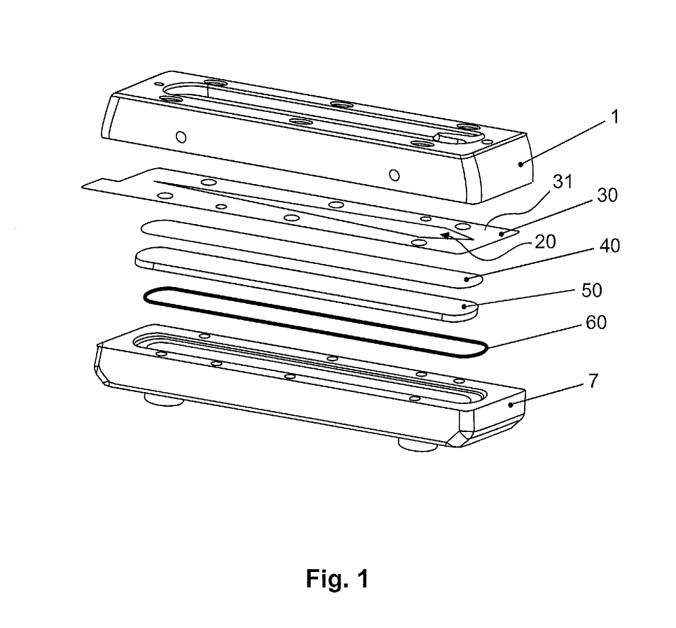

The duct housing according to prior art shown in FIG. 1 comprises an upper housing part 1, a spacer film 30, a membrane 40, a frit 50, a sealing element 60, as well as a lower housing part 7, which can be assembled and/or mounted on top of each other in the inverse order. The spacer film 30 comprises a cut-out section and/or a recess, which forms a duct 20 in the assembled state. The duct 20 is discernible in FIG. 1 as a trapezoid, i.e. nearly trapeze-shaped volume. The duct 20 forms a separated volume for the field-flux fractionation. During the assembly of the duct housings of prior art the spacer film 30 is placed between the two housing parts 1,7 to be screwed together, as shown in FIG. 1. The spacer film 30 further rests in the assembled state on the membrane 40 usually embodied as an ultra-filtration membrane, which even in the installed position is supported in turn by a frit 50 commonly made from sintered metal. The frit 50 rests together with a sealing element 60 surrounding it, here shown in the form of a sealing ring, on the lower housing part 7.

The components listed are clamped to each other in the assembled state. Thus, it represents a kind of sandwich construction, in which all above-mentioned components are arranged between the upper housing part 1 and the lower housing part 7. By tightening the screws provided for the connection the spacer film 30 contacts both the upper housing part 1 and the lower housing part 7 under pressure in a sealing fashion. For this purpose, the circumferential edge section of the spacer film 30 shows a sealing surface 31 at both sides to seal the upper housing part 1 and the lower housing part 7.

During the field-flux fractionation a cross-flow is guided out of the duct 20 by the membrane 40, the frit 50, and then by a bore in the lower housing part 7, not shown, while the fluid components and/or particles to be separated cannot pass the membrane 40 but remain together with the fluid portion in the duct 20 and exit by an outlet provided at the end of the duct 20. Here, the conditions required for field-flux fractionation preferably need a pressure from 5 to 15 bar. Sealing areas at the assembled housing and/or duct 20 must withstand such pressure so that neither solvents nor sample components can exit. In case of leakage, it must be distinguished between exterior and interior leakage.

In case of an exterior leakage, liquid exits into the environment, e.g., from the area below the membrane 40. This is particularly the case in weakly or irregularly tightened screws, a damaged sealing element 60, or a damaged lower housing part 7. Potential causes also include the failure of the seal between the spacer film 30 and the upper housing part 1. This case particularly occurs when contaminants, such as dust or hair comes between the sealing area 31 and the bottom of the upper housing part 1, preventing sufficient sealing over the entire sealing area 31. Additionally, a leakage may also occur between the spacer film 30 and the lower housing part 7.

However, interior leakage is defined as a leakage from the duct 20, leading fluid to reach between the bottom part of the upper housing part 1 and the spacer film 30 or between the spacer film 30 and the membrane 40. Here, the leakage flow reaches the fluid flow and is here drained with it. In this case it is particularly difficult to detect any leakage and/or to detect the cause for the leakage because the draining of fluid at the outside of the duct 20 cannot be regularly observed. Such a broken seal can perhaps only be proven indirectly by perhaps a massively weakened or completely missing detector signal, however then the sample is lost forever. The installation of pressure sensors in the interior duct volume or in the area downstream in reference to the membrane in the flow direction can indicate such a leakage by recognizing the difference pressure, however in case of minimal leakages the pressure drop is usually below the margin of error of the pressure sensors and thus remains undetected in most cases, with accordingly poor measuring results. Thus, a leakage can occur below or above the spacer film 30.

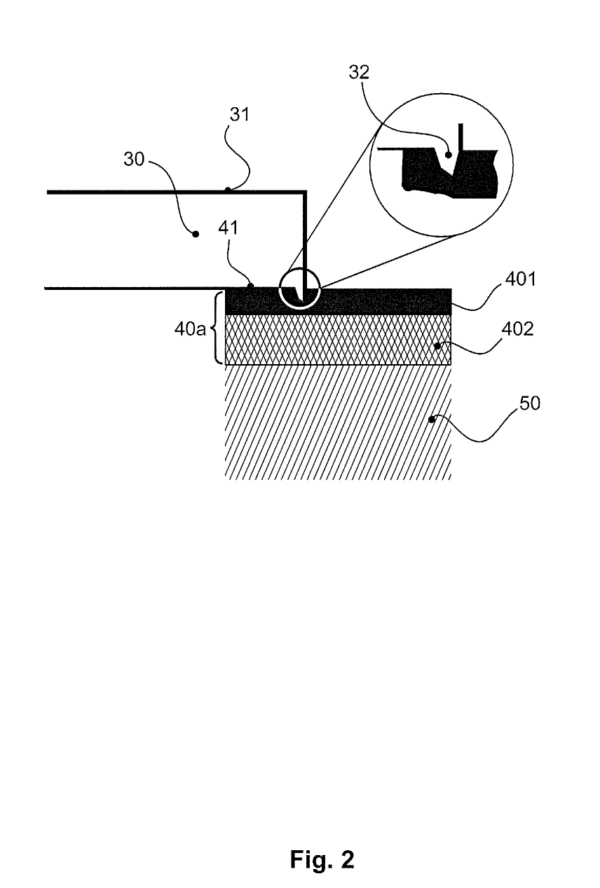

It is discernible from FIG. 2 that the membrane may also be provided as a composite membrane 40a, which is composed from a filtration layer 401 and a carrier material 402. The penetration of fluid into the area between the spacer film 30 and the membrane 40 and/or the filtration layer 401 and/or the area between the upper housing part 1 and the spacer film 30 shall be prevented, as described above, on the one hand by the sealing area 31, for which the upper housing part 1 must be screwed against the lower housing part 7 with a great clamping force. On the other hand, the sealing effect underneath the spacer film 30 shall be improved by a burr 32, which may develop during the production of the spacer film 30, namely e.g., when cutting the section forming the duct by a knife, but also in modern laser cutting. The burr 32 is pressed into the filtration layer 401 when the upper 1 and the lower housing part 7 are pressed against each other and this shall support the sealing effect in the area between the spacer film 30 and the filtration layer 401 such that it cuts into the membrane 40 and/or the filtration layer 401 of the composite membrane 40a. The burr 32 is commonly only embodied with a thickness in a range of a few tenths of a millimeter, however in case of high pressure applied between the housing parts 1, 7 it can cut into the filtration layer 401 through the entire depth. The carrier material 402 of the composite may not be compromised, though, so that the burr 32 should mandatorily be embodied with the correct dimension.

Disadvantages of the sealing principle shown in FIGS. 1 and 2 result, e.g., from the fact that the burr 32 develops as a byproduct during the production of the spacer film 30, and that commonly it is not possible to precisely adjust its shape and thickness. In particular gaps or thickenings, which might occur during a change of the direction of cutting by a laser and/or a knife, lead to an uneven burr 32 and thus to this sealing principle failing. Additionally, the effect of this auxiliary sealing principle cannot be precisely assessed and predetermined. If the burr 32 is embodied with insufficient thickness, e.g., satisfactory sealing would only be achieved here by an even higher compression, while the burr 32 then would penetrate the carrier material 402 at another point. Thus, the burr 32 may never be embodied too thick, because otherwise it cuts into the entirely solvent and sample permeable carrier material 402. Instead of sealing, then a massive leakage would develop.

Additionally, disadvantages develop with regards to the requirements and/or experiences needed for optimal assembly. Since the filtration layer 401 of the membrane being moistened with solvent can swell by 20 to 60 μm the membranes 40 are preferably installed in a wet state in order to prevent any excessively deep cutting of the burr 32. However, this requires increased care of the user handling it, because the wet membrane can slip on the frit 50 and/or slide uncontrolled by way of floating. Maintaining the precise position of the membrane 40 and/or composite membrane 40a without touching it is very important when assembling the duct housing. However, when the composite membrane 40a contacts e.g., the sealing element 60 (cf. FIG. 1) it can already be damaged simply by such a contact and then it is no longer able to properly seal. Usually such a damage can only be detected upon start-up operation, which is time-consuming and requires extensive correction work.

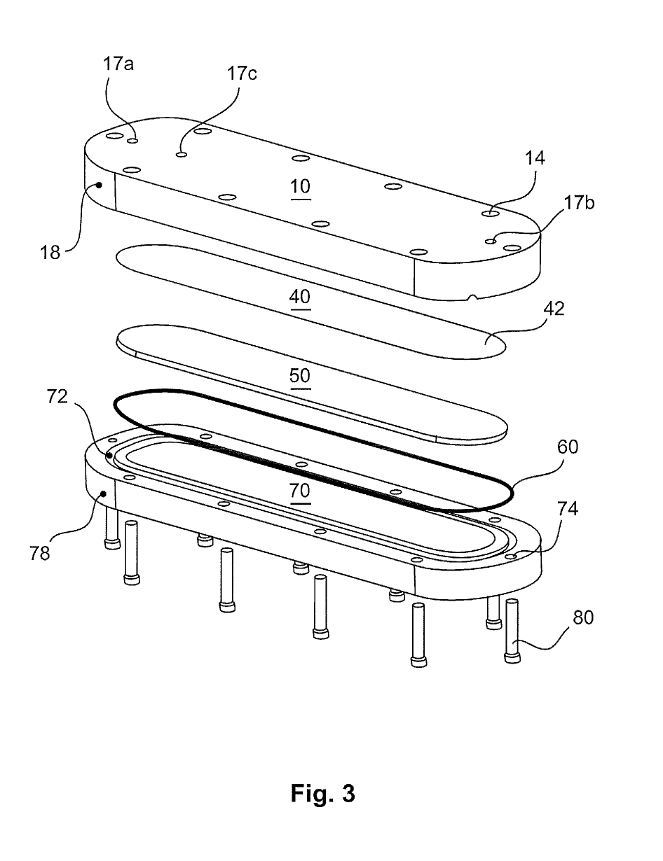

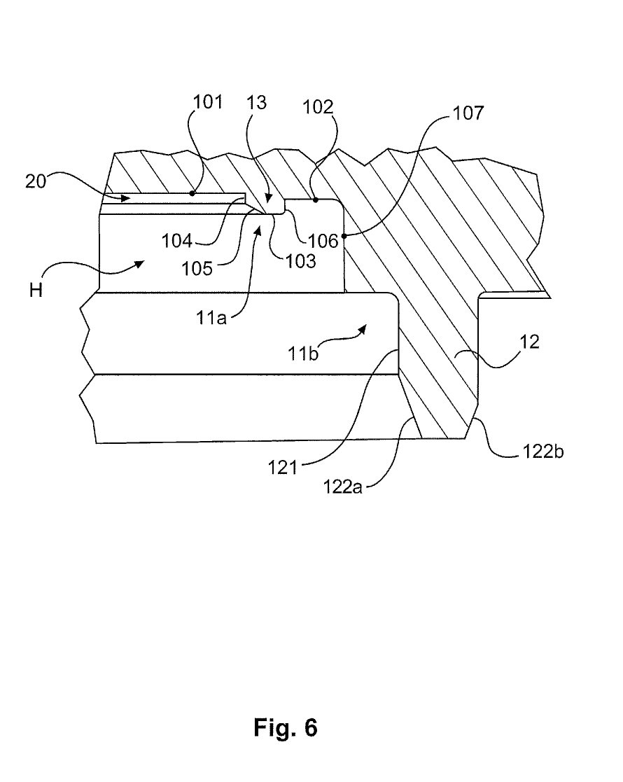

FIG. 3 shows a preferred embodiment of the duct housing according to the invention, comprising a first duct housing part 10, the membrane 40, the frit 50, the sealing element 60, as well as the duct housing part 70. In the assembled state, the first duct housing part 10 rests directly on a membrane surface 42 of the membrane 40, i.e. here no spacer film or any other separate component forming the duct is present. However, in the preferred exemplary embodiment shown in FIG. 3 the duct 20 is essentially formed by the first duct housing part 10 and/or integrated in the first duct housing part 10 (cf. FIG. 6). It has shown that by defining the duct 20 and/or the separated volume via the first duct housing part 10 a sealing surface and/or a section to be sealed can be omitted so that only one linear seal must be ensured between the first duct housing 10 and the membrane 40 as well as an exterior seal between the first duct housing part 10 and the second duct housing part 70.

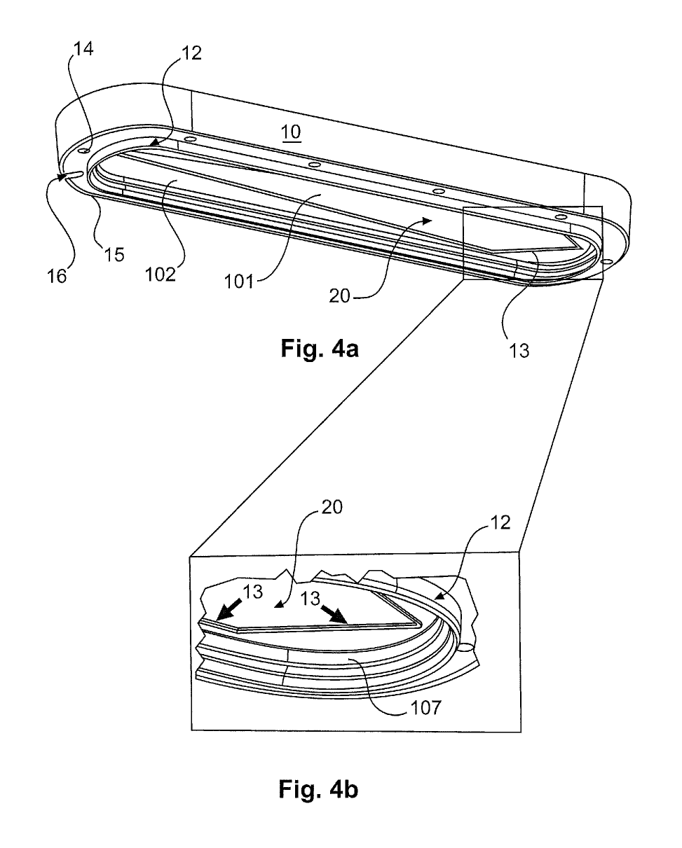

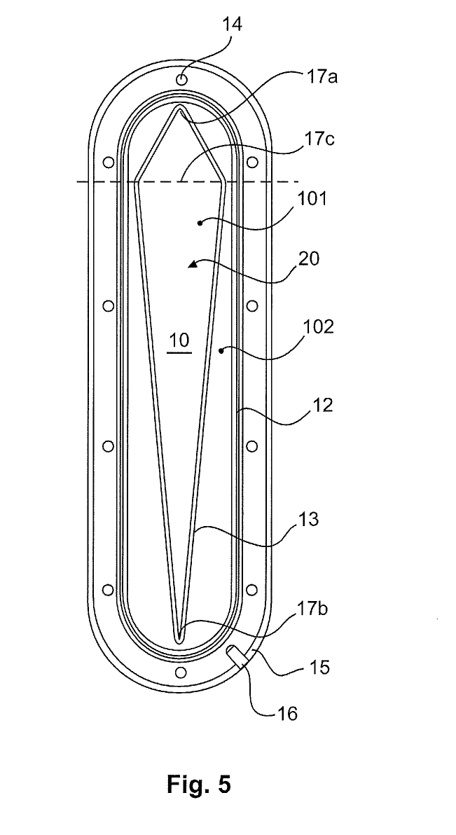

The FIGS. 4a and 4b as well as 5 show the first duct housing part 10 from the bottom and disclose the duct 20, which is limited by an interior projection 13. Inside the projection 13 a first area 101 and outside the interior projection 13 a second area 102 is formed, at which the interior projection 13 abuts. It is discernible in FIGS. 5, 6, and 7 that the second area 102 is located between the interior projection 13 and an exterior projection 12 and positioned in a level at least almost parallel in reference to the level in which the first area 101 is located. The interior projection 13 is off-set like a bar from the first area 101 and the second area 102, as shown in detail in FIG. 6. Bores 14 are discernible in the first duct housing part 10, which are arranged outside an exterior projection 12 along the exterior projection 12. It is easily discernible from FIG. 5 that the bores 14 are arranged to accept connection elements at approximately the same distances from each other and from the exterior projection 12. At the outside of the jacket area of the first duct housing part 10 and abutting it an edge is provided in the form of a stop 15, by which the first 10 and the second duct housing part 70 can come into contact with each other. The stop 15 is embodied in the edge area as a circumferential bar, which is interrupted only in the area of a recess 16. The recess 16 is here provided in the form of a bore or a cut-out ending in front of the exterior projection 12.

At the two tapered ends of the duct 20, in the first duct housing part 10, a bore-like passage is provided each, as indicated in FIG. 5 by the reference characters “17a” and “17b”. These passages 17a and 17b, with generally the passage 17a being used as an inlet port and the passage 17b as an outlet port, are also shown in FIG. 3. As further indicated in FIG. 5 by the reference character “17c”, if so required, in the area of the greatest width of the duct 20 another bore-like passage may be provided, particularly for the injection of a sample; said additional passage 17c is also discernible in FIG. 3.

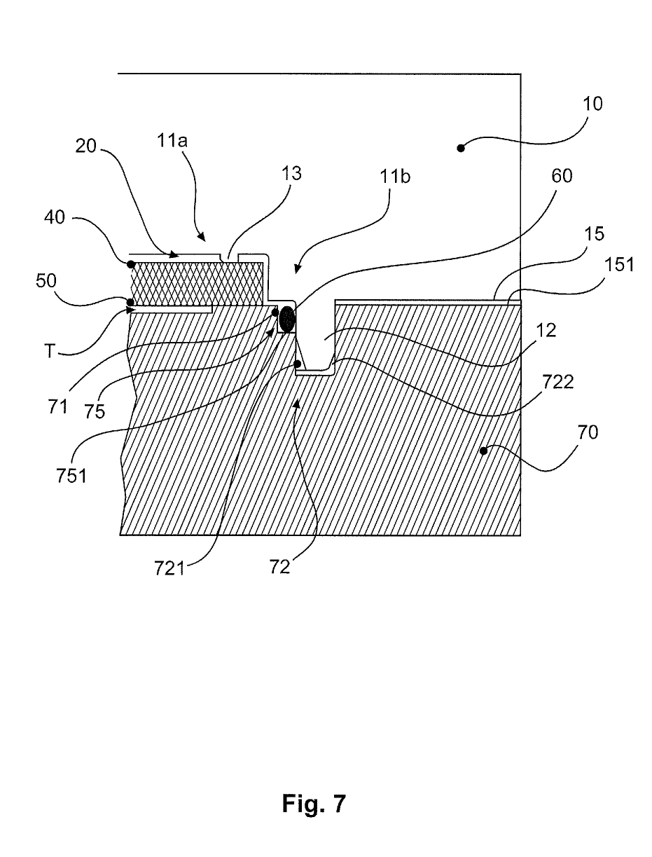

In FIG. 6 it is shown in detail how the exterior projection 12 is preferably embodied. The exterior projection 12 comprises an interior bevel 122a, which points in the direction towards the duct 20. This way, the sealing element 60 (cf. FIG. 3) can be pressed into an exact position during the assembly of the duct housing parts. Further, the exterior projection 12 comprises an exterior bevel 122b, which is inclined opposite towards the interior bevel 122a. Thus, the exterior projection 12 tapers towards its end. By the exterior projection 12 essentially the purpose of centering the first 10 to the second duct housing part 70 is addressed, however the exterior projection 12 forms at least partially a second sealing area 11, in which a sealing element 60 (cf. FIG. 7) can be arranged.

Additionally, it is shown in FIG. 6 how the interior projection 13 may be embodied. The projection 13 essentially determines the first sealing area 11a with a pressure area 1-3 as well as the interior bevel 105. The first sealing area 11a is distanced from the second sealing area 11b, particularly in the direction orthogonally in reference to the level in which the membrane 40 (cf. FIG. 7) is arranged. A fourth area 107 is embodied adjacent and approximately perpendicularly in reference to the second area 102 at the bottom of the first duct housing part 10. In the exemplary embodiment shown an accepting space H is provided for the membrane 40 and the frit 50, which as particularly discernible in FIG. 6 is limited in the assembled state laterally and towards the top by the first duct housing part 10, particularly essentially by the first area 101 and the second area 102 as well as by the fourth area 107, and, as shown in FIG. 7, towards the bottom by the second duct housing part 70.

In FIG. 7 the components are shown in the assembled state, with here the condition of a first assembly step being shown, according to which the first duct housing part 10 and the second duct housing part 70 are not yet finally stressed towards each other. Although in the illustration of FIG. 7 an exterior sealing is created in the second sealing area 11b by the sealing element 60, however in the first sealing area 11a the projection 13 rests only on the membrane 40, i.e. the projection 13 contacts the surface of the membrane 40 without compressing the membrane 40, though. Further it is discernible that by the stop 15 a contact area 151 is formed, which projects in reference to the remaining part of the bottom of the first duct housing part 10, and which in reference to the dimensions of the first duct housing part 10 is embodied relatively narrow so that here only a small area needs to be processed in order to yield good tolerance values for a gap-free arrangement of the first duct housing part 10 at the second duct housing part 70 and to predetermine in advance the impression depth as precisely as possible, particularly in a constructive manner.

According to one embodiment in the assembled state the first duct housing part 10 may laterally limit the membrane 40 as well as the frit 50 with a fourth area 107 embodied as a type of lateral wall so that any displacement of the membrane 40 and/or the frit 50 can be excluded. In the assembled state, here a free section may develop, as shown, between the fourth area 107 and the frit 50 and/or the membrane 40, however it is also possible that the fourth area 107 is arranged in the proximity of the frit 50 and/or the membrane 40 or directly contacts the frit 50 and/or the membrane 40 such that by the first duct housing part 10 a type of centering is created for the frit 50.

While the separated volume being formed by the duct 20 between the first duct housing part 10 and the membrane 40, a cross-flow and/or cross-flow dead volume T is formed in the area of the frit 50, upon which the membrane 40 is arranged, towards the second duct housing part 70. In the assembled state shown in FIG. 7 the exterior projection 12 is already in a position in which it engages a groove-like recess 72 of the second duct housing part 70. The recess 72 is limited by two opposite areas, namely an interior groove area 721 and an exterior groove area 722, and the exterior projection 12 can be guided and/or centered by these areas. The sealing element 60 is arranged at the second duct housing part 70 at a stop 75. The stop 75 is limited by a second sealing area 71, which points laterally in the direction towards the outside to the exterior projection 12, as well as by a stop area 751, which the sealing element 60 can contact. A sealing can occur both via the second sealing element 71 as well as via the stop area 751. This also applies for the two areas at the first duct housing part 10, which the sealing element 60 can contact.

In order to seal the duct housing, in a first step the first duct housing part 10 and the second duct housing part 70 are placed against each other. For this purpose, the sealing element 60 is inserted into the stop 75 at the second duct housing part 70, and subsequently the frit 50 with the membrane 40 can be arranged on the second duct housing part 70. Now it is only required to mount the first duct part 10, i.e. it is no longer required to align a spacer film in reference to the membrane 40 or the second duct housing part 70. The assembly is therefore facilitated by the exterior projection 12 in the first duct housing part 10 and the corresponding groove-like recess 72 in the second duct housing part 70 and here the first duct housing part 10 is correctly aligned in reference to the second duct housing part 70. This way, relative motions between the membrane 40 and the projection 13 can be largely excluded during assembly.

Then, in a second step the connection elements 80 are provided and the two duct housing parts 10, 70 are positioned. The sealing element 60 here embodied in the form of an O-ring, is now positioned fixed between the duct housing parts 10, 70 and under slight tightening of the connection elements 80 (cf. FIG. 3) already leads to a sealing towards the outside, i.e. a sealing in the second sealing area 11b. A potentially imprecisely inserted sealing element 60 can here be automatically brought into the right position by the exterior projection 12 upon closing by the interior bevel 122a and an abutting interior lateral area 121 (FIG. 6) serving during the assembly as guides for the sealing element 60 in order to press it in the correct position into the stop 75.

Only in another step sealing towards the inside, i.e. in the first sealing area 11a is achieved by a complete tightening of the connection elements 80. For this purpose, the interior projection 13 presses against the membrane 40 located inside, perhaps still dry. The dimensions and/or tolerances are here sized such that the first duct housing part 10 and the second duct housing part 70 can contact each other via the contact area 15 without any gaps and here the membrane 40 is compressed by the projection 13 as intended. Here, the sealing towards the outside remains unchanged. Here, the depth of impression can be predetermined by various constructive measures, e.g., via the height of the stop 15. This way it can be ensured that the membrane 40, independent from the specific amount of force applied to tightening the first duct housing part 10 with the second duct housing part 70, cannot be compressed excessively or even be cut or pierced. Further, an optic control is possible, because as soon as the duct housing parts 10, 70 contact each other without any gaps the intended impression depth is reached. In case the connection elements 80 are embodied as screws they can be tightened with a torque wrench with maximally 4 Nm, for example. The force applied by the connection elements 80 and/or the part of the force not directly transmitted from the first 10 to the second duct housing part 70 then impacts only a small portion of the surface of the membrane 40 and is thus transferred via the third area 103 and perhaps also the interior bevel 105 of the circumferential projection 13 to the membrane 40 so that the duct 20 can effectively be sealed towards the inside.

The duct housing 1 according to the invention can therefore be assembled easier and thus due to the two-step sealing principle less force and/or pressure is required than in prior art. Further, e.g., in case of membranes 40 with different thicknesses, specific distances may also be realized between the first duct housing part 10 and the second duct housing part 70, particularly via a spacer between the first duct housing part 10 and the second duct housing part 70, which e.g., shall be arranged in the area of the stop 15 and/or the contact area 151.

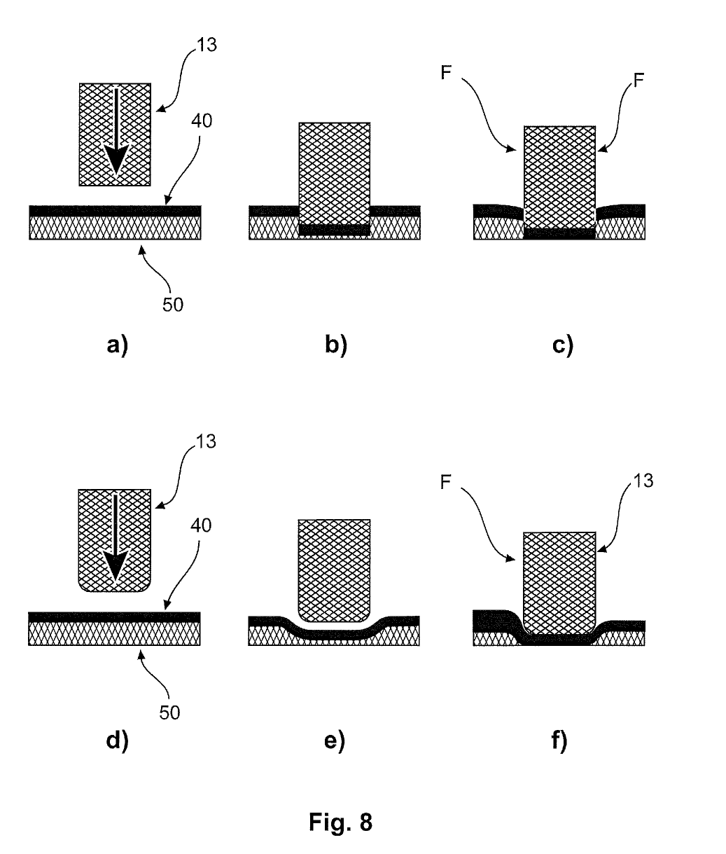

FIGS. 8a through 8c show how the membrane 40 can be stressed if the projection 13 was embodied with a sharp edge, as taught by duct housings known from prior art with a burr at the spacer film. In such a case, by the edges of the projection 13 the impressed area of the membrane 40 could be severed from the remainder of the membrane 40 and in the worst case scenario impressed deeply into the frit 50, leading to an interior leakage. It is discernible from 8c that even in case of a swelled membrane 40 a sealing might be impossible in case of a sharp-edged profile so that fluid F could occur at both sides of the projection 13.

Contrary thereto, FIGS. 8d through 8f is shown such that a pressure applied upon the membrane 40 when the projection 13 is embodied according to the invention, thus at least towards the inside, comprises a bevel or rounding. It is discernible that the membrane is impressed without the surface of the membrane being engaged. In particular, FIG. 8e illustrates that according to the invention it is indicated that by precisely rounding or beveling the projection 13 along the edges of its pressure area 103 a sealing compression of the membrane 40 and perhaps also the frit 50 can be achieved without damaging the surface of the membrane. This also applies for a swelled membrane 40 (cf. FIG. 8f).

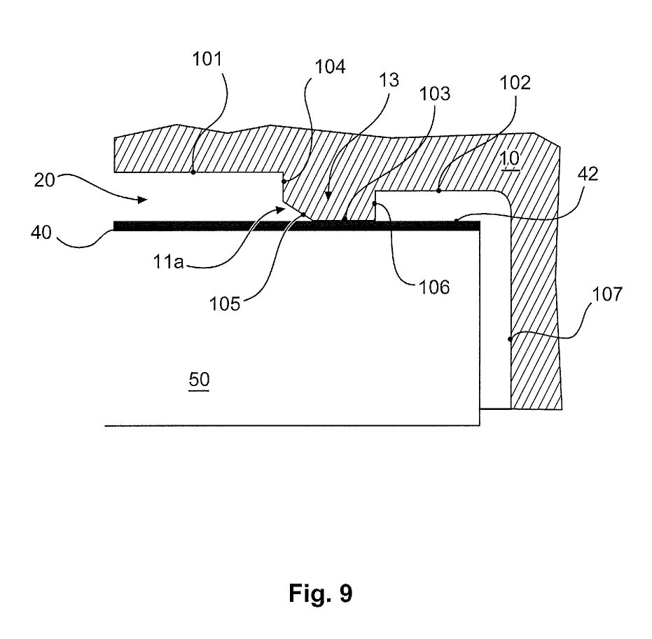

Accordingly, the interior projection 13 is provided with an interior bevel 105, which connects the third area 103 provided for the sealing engagement with the surface 42 of the membrane to an interior lateral surface 104 at the interior projection 13, as discernible in detail in FIG. 9. The detailed illustration of FIG. 9 shows the position of the first duct housing part 10 in reference to the membrane 40 in a pre-assembled state, in which the projection 13 not yet noticeably impresses the membrane 40. In the finished assembled state, therefore the first sealing area 11a is not only formed by the third area 103 but also at least sectionally by the bevel 105.

When the first duct housing part 10 is now clamped to the second duct housing part 70 (cf. FIG. 3) the projection 13, particularly the third area 103, is pressed onto the surface 42 of the membrane, and a certain impression depth develops by which the surface 42 of the membrane is pressed in the direction of the frit 50. Depending on the impression depth and the embodiment and/or consistency of the membrane 40 and the frit 50 here a certain pressure develops, by which sufficient interior sealing of the duct 20 can be ensured in reference to the environment. Here, when needed, in addition to the membrane 40 the frit 50 can also be compressed by a predetermined amount.

### LIST OF REFERENCE CHARACTERS

1 upper housing part

7 lower housing part

10 first duct housing part

101 first area

102 second area

103 third area (pressure area)

104 interior lateral area

105 interior bevel

106 exterior lateral area

107 fourth area

11a first sealing area

11b second sealing area

12 exterior projection (guiding edge)

121 (interior) first sealing area

122a interior bevel

122b exterior bevel

13 projection (circumferential contour)

14 bore in the first duct housing part

15 stop (edge)

151 stop area

16 recess

17 passage

18 first jacket area

20 duct

30 film

31 sealing area between the spacer film and the upper and/or lower housing part

32 burr

40 membrane

401 filtration layer

402 carrier material

40a composite membrane

41 sealing area between the spacer film and the membrane

42 membrane surface

50 frit

60 sealing element

70 second duct housing part

71 second sealing area

72 groove-like recess (guiding groove)

721 interior groove area

722 exterior groove area

75 stop (sealing stop for exterior sealing)

751 stop surface

78 second jacket area

80 connection element

F fluid

H accepting space

T volume under the membrane (cross-flow dead volume)

What is claimed is:

1. A duct housing for a field-flux fractionation device with a preferably plate-shaped first duct housing part and a preferably plate-shaped second duct housing part, with the two duct housing parts being located over top of each other in the assembled state and forming a duct, which at a first side is limited by a membrane arranged between the two duct housing parts sealing against the outside and thus a separation volume is determined between the first duct housing part and the membrane, comprising a first sealing area provided at the first duct housing part and a circumferential projection, projecting from a first area defined by the first duct housing part and in the assembled state limiting a second side of the duct and surrounding the duct with the first sealing area in the assembled state engaging the membrane in a sealing fashion.

2. The duct housing according to claim 1, wherein the duct housing is embodied such that the projection compresses the membrane in the assembled state.

3. The duct housing according to claim 1, wherein the first duct housing part and the second duct housing part are embodied such that in the assembled state they directly contact each other at least sectionally.

4. A duct housing according to claim 1, wherein the projection comprises an interior bevel or a rounding, pointing inwardly towards the duct, and a third area by which the projection presses upon the membrane.

5. The duct housing according to claim 1, further comprising a second sealing area, in which a first sealing area is provided at the first duct housing part and a second sealing area at the second duct housing part, which in the assembled state cooperates with the first sealing area in order to yield a sealing connection directly between the first and the second duct housing part for an exterior sealing.

6. A duct housing according to claim 5, further comprising a stop provided in the second sealing area, at which the second sealing area is embodied to accept a preferably annular sealing element, preferably pointing outwardly, and with the sealing element in the assembled stated each contacting the first sealing area as well as the second sealing area in a sealing fashion.

7. The duct housing according to claim 6, further comprising an exterior projection arranged outside the projection surrounding the duct at the first duct housing part and at the second duct housing part a groove-like recess to accept the exterior projection, and wherein the first sealing area is formed by an interior lateral wall of the exterior projection.

8. The duct housing according to claim 1, further comprising an exterior projection arranged outside the projection surrounding the duct at the first duct housing part and at the second duct housing part a groove-like recess to accept the exterior projection.

9. The duct housing according to claim 8, with the first sealing area being formed by an interior lateral wall of the exterior projection.

10. The duct housing according to claim 1, wherein the duct comprises a flat duct.

11. A duct housing part for a duct housing of a field-flux fractionation device, wherein in the assembled state the duct housing part rests on another duct housing part and together with it forms a duct, which is limited at a first side of a membrane arranged between the two duct housing parts sealing towards the outside and thus forming a separated volume between the duct housing part and the membrane, comprising a first sealing area, which comprises a circumferential projection, which projects from a first area defined by a duct housing part and in the assembled state limited by a second side of the duct and in the assembled state engages the membrane in a sealing fashion and surrounds the duct.

12. The duct housing according to claim 11, wherein the duct is embodied as a flat duct.

13. A method for assembling a duct housing provided for field-flux fractionation, with the duct housing being formed by elements arranged over top of each other, particularly a first duct housing part and a second duct housing part, a membrane, and a sealing element, the method comprising:
the elements to be arranged over top of each other are brought into a position in reference to each other, with the membrane being arranged directly underneath the first duct housing part,
the first duct housing part and the second duct housing part is plugged together and via connection elements are made to contact under the creation of a first force such that an exterior seal can already be achieved via the sealing element towards the outside in reference to the environment, and
the connection elements are fixed such that the first duct housing part and the second duct housing part can be clamped to each other via a defined second force greater than the first force, so that an interior sealing can be created between the membrane and the first duct housing part.
